(19) United States
(12) Patent Application Publication
(10) Pub. No.: US 2011/0095230 A1
(43) Pub. Date: Apr. 28, 2011

(54) DOPED RARE EARTHS ORTHOSILICATES USED AS OPTICAL DEVICES FOR RECORDING INFORMATION

(75) Inventors: Alberto Anedda, Quartu Sant'Elena (IT); Pier Carlo Ricci, Cagliari (IT); Daniele Chiriu, Carbonia (IT)

(73) Assignee: UNIVERSITÀ DEGLI STUDI DI CAGLIARI, Cagliari (CA) (IT)

(21) Appl. No.: 12/922,045

(22) PCT Filed: Mar. 24, 2009
(86) PCT No.: PCT/EP09/53461

§ 371 Date: Jan. 11, 2011

(30) Foreign Application Priority Data
Mar. 26, 2008 (IT) CA2008A000008

(51) Int. Cl. C09K 11/79

(52) U.S. Cl. 252/301.4 F

(57) ABSTRACT

The present invention refers in a first aspect thereof to a new method for information storage and retrieval by means of rare earth doped orthosilicates having a trap density comprised between 10¹⁵ and 10²⁰ traps/cm³ and to devices using such a new method for storing and retrieving information.

The present invention relates to a new method for storing and retrieving information by means of doped rare earths orthosilicates as well to systems and devices employing such method.

Optical recording media, reliably storing the recorded information and coupled with an easy way to read and retrieve such information may find use in a wide range of different applications, among the most interesting ones there being electronic circuitry design, optical memories, dosimetry and radiographic imaging.

Doped rare earths orthosilicates are a class of optical materials that is typically exploited by virtue of their fast response time, in fact after being exposed to a suitable excitation radiation they quickly re-emit lights after a very short time, typically in the range of few tens of nanoseconds and up to few milliseconds. For this reason they are employed in applications such as part of the sensing system in ionizing radiations detection.

One of the most recent and important uses of these types of crystals is in the medical diagnostic field, for example in computer tomography, as described in U.S. Pat. No. 7,403,589, where it is highlighted the desired effect of an extremely fast response time, preferably less than 50 ns.

These materials are typically referred to in the technical field as scintillators, and the main research lines are devoted in improving their characteristics for applications where they are the constituting part of radiation detecting systems, more specifically both in improving the response efficiency and in reducing the scintillator response time, since in these applications the higher the lag time between the ionizing radiation absorption and the crystal light re-emission, the worse.

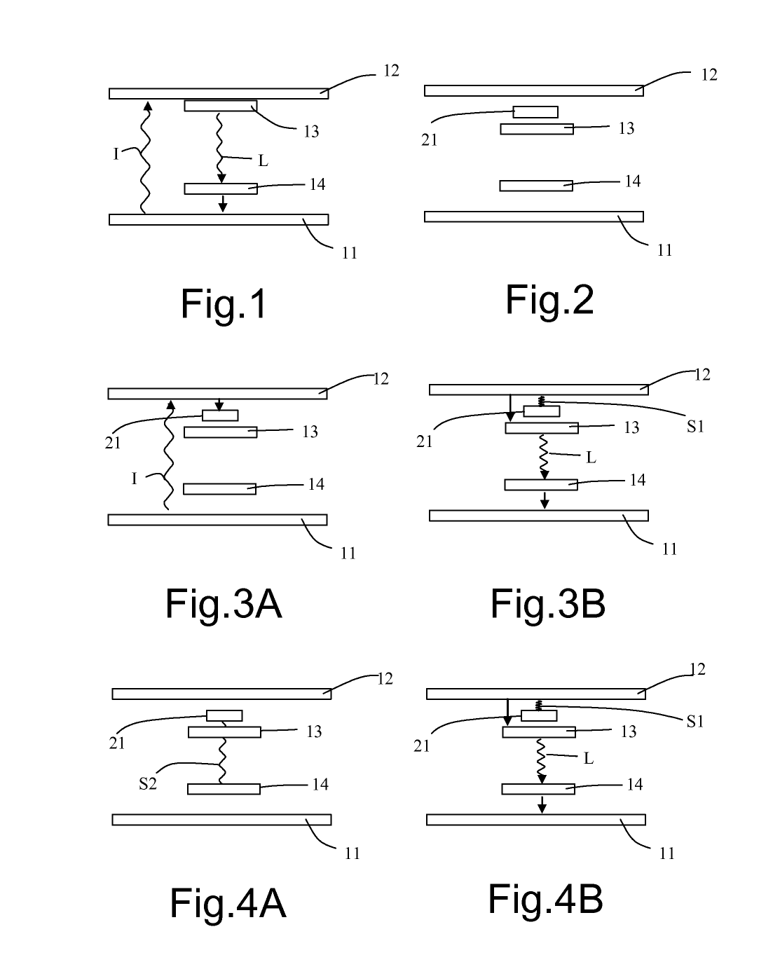

The mechanism governing the behavior of an ideal scintillator is depicted in FIG. 1, where the valence band is indicated with 11, the conduction band with 12, the two most representative levels of the rare earth dopant are indicated with 13 and 14. Upon the absorption of an ionizing radiation I, an electron jumps from the valence band of the scintillating crystal to its conduction band, then in about 40 ns goes back to the valence band emitting some light in the process. The passage from the conduction to the valence band occurs via a transition to the upper energetic level of the rare earth 13 (enabled by the close energetic proximity of such level with the conduction level), the jump from the upper energetic to the lower energetic level of the rare earth 14 and the consequent emission of the radiation L of wavelength determined by the energy level distribution, and finally the transition to the valence level.

The presence of impurities or defects in the crystal structure may create “traps”, i.e. additional active energy levels that interfere with the above depicted scheme, resulting in a non-ideal behavior, since such traps may cause loss of radiation, resulting in a less efficient crystal, or delays in its response. Such delays are detrimental for the use as scintillators, since they may also cause “false” or non controlled responses when these are used in detection systems where the main function and purpose of these scintillating crystals is to “shift” the incoming radiation wavelength to a different and more easily detectable wavelength, for example emitting visible light.

It is to be remarked that the definition of traps sometimes has a slight different definition in the technical field and typically is limited only to stoichiometric defects linked to ion vacancies within the crystal structure.

The inventors during their research activity have found that some of these crystals possessed some of the above outlined detrimental characteristic that rendered them unsuitable as scintillators, since the absorbed radiation was not immediately released but there was a certain delay between the radiation absorption and the crystal luminous emission.

Upon further investigation and research work the inventors have found how to control and predict the result of the interaction of these defective crystals with high energy radiation, thus coming to conceive the present invention, that in a first aspect thereof refers to a new method for information storage and retrieval employing as storing element doped rare earth orthosilicates characterized in that said doped rare earth orthosilicates present a trap density comprised between 10¹⁵ and 10²⁰ traps/cm³.

The invention will be further described with reference to the drawings in which:

FIG. 1 shows the energetic level and functional scheme of an ideal scintillator crystal;

FIG. 2 shows the energetic level scheme of a crystal suitable to carry out the method of the present invention;

FIGS. 3A and 3B show a first functional scheme for storing and reading the information according to the present invention;

FIGS. 4A and 4B show a first functional scheme for storing and reading the information according to the present invention;

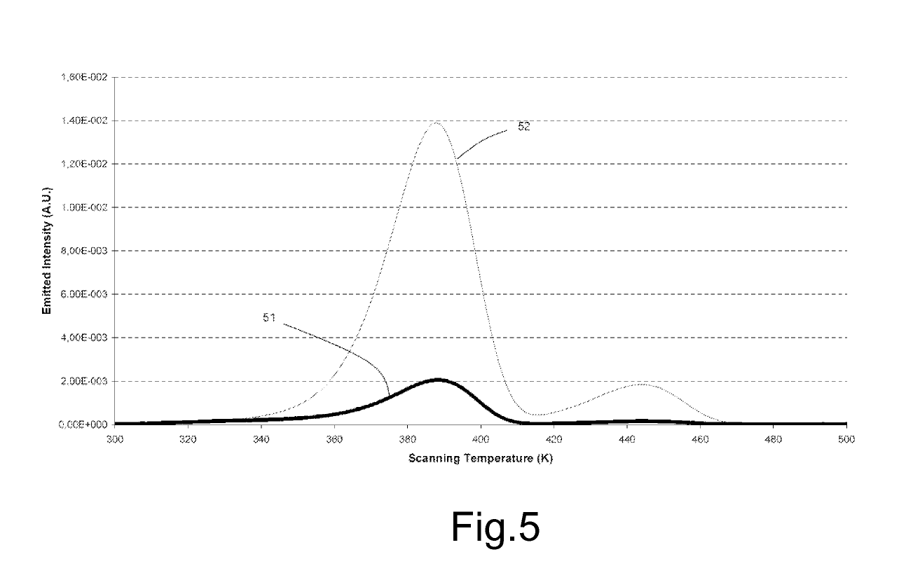

FIG. 5 shows a comparison of thermoluminescence spectra of crystal grown in air and in Argon;

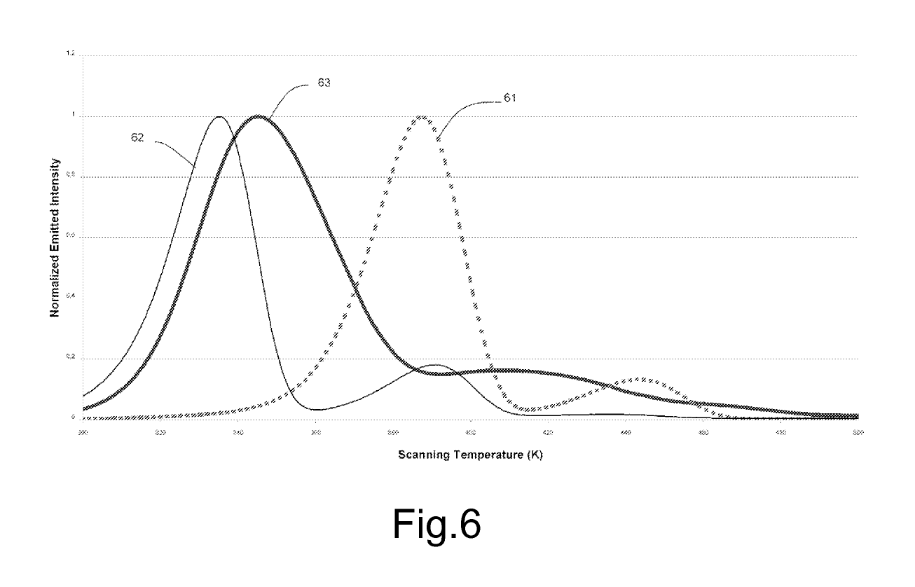

FIG. 6 shows a comparison of thermoluminescence spectra obtained with different material apt for carrying out the invention;

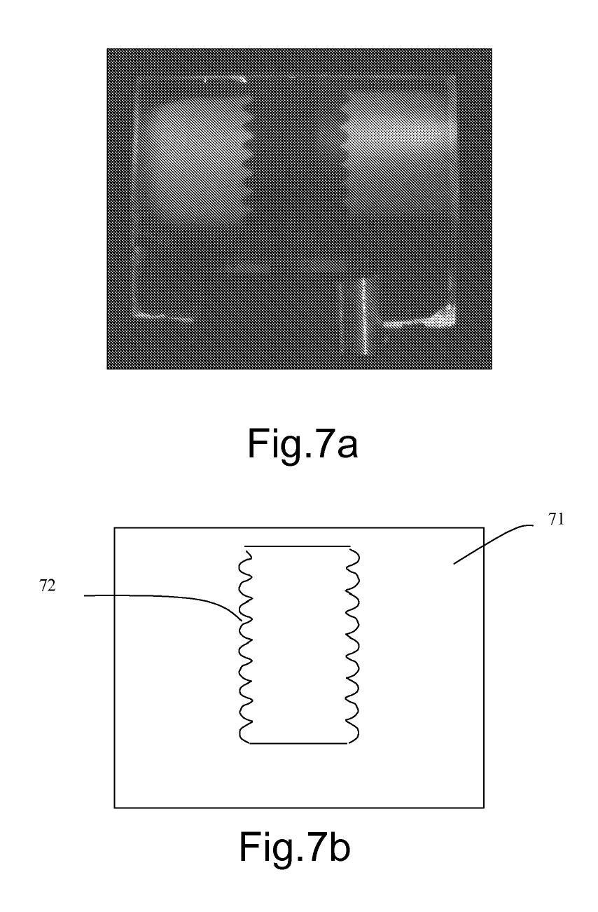

FIG. 7A shows a radiographic image recorded and read with the method of the present invention, the essential elements of such image being schematically represented in FIG. 7B; and

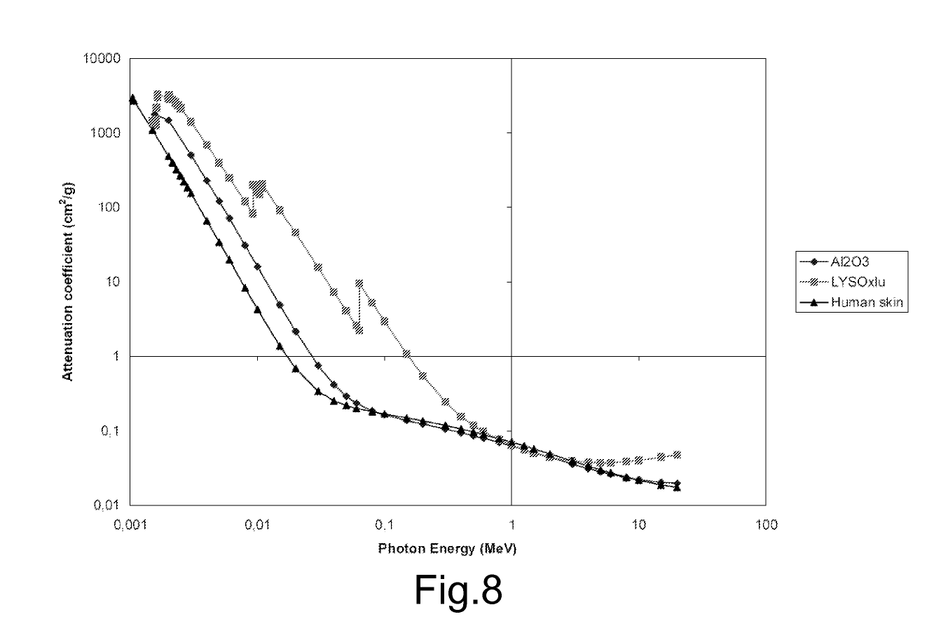

FIG. 8 shows a comparison among the radiation stopping power of crystals useful to carry out the method of the invention, the human skin and another optically active material.

FIG. 1 has been already described with regard to the explanation of the energy scheme level of a scintillator crystal. It is to be underlined that the depicted energy levels in this and the following figures, have sole a representative function and are in no way an indication of the true or relative value of such levels. In particular the energetic level of the traps in FIGS. 2-4 is much closer to the energy of the conduction band, and if depicted correctly those would result almost superimposed, leading to a representation that although more correct from a scientific standpoint, would be quite difficult to understand.

The inventors have found that if the doped rare earth orthosilicate crystal has a certain density of defects then it is able to store information recorded by means of an external radiation source, information that can be read later after a suitable external excitation is provided. The preferred way to release or read the stored information is by impinging laser radiation on the rare earth orthosilicate crystal.

An energetic scheme of an orthosilicate useful to carry our the invention is depicted in FIG. 2, where the trapping element energy has been depicted as 21.

A first recording scheme is shown in FIG. 3A: in this case a high energy radiation, i.e. an external source with an energy higher with respect to the gap between the conduction and the valence band, causes an electron transition between said bands. Some light will be quickly re-emitted according to the usual scintillator behavior, but some electron will be captured in the energetic level 21, actually “writing” the crystal, storing an information with regard to the exposure to the incoming high energy radiation.

The reading process is shown in FIG. 3B, and envisions the use of external means for exciting the electrons stored in the trap to move them into valence band 12 and cause the light emission according to the usual scintillator mechanism.

Such external exciting means may be provided by a light source, typically a low power laser, or may be thermal means or, in a less common embodiment, a combination thereof.

The recording and reading process shown in FIGS. 3A and 3B are particularly useful in medical applications, with particular reference to dosimetry and radiographic imaging.

An alternate recording mechanism is depicted in FIG. 4A: in this case the writing source has an energy not less than the gap between the lowest dopant energy level and the highest trap energy level. The reading mechanism is similar to the one previously described with reference to FIG. 3B.

This second method for writing information into the crystal is preferred for the optical memory and electronic circuit design.

As it is possible to understand from the above reference figures describing the optical material crystal writing and reading mechanism according to the present invention, the density of traps, also referable as defects, within the crystal structure represents the key point for the successful use of such material.

In particular the inventors have found that the trap density shall be comprised between 10¹⁵ and 10²⁰ traps/cm³, but improved performances are achieved with a trap concentration comprised between 10¹⁶ and 10¹⁹ traps/cm³ and even more preferably between 2*10¹⁸ and 9*10¹⁸ traps/cm³.

In particular the two narrowest intervals specified are the ones optimizing the density defect density for information storage, without a significant re-capture of electrons during the reading mechanism, that would result in non-optimal performances and drawbacks.

In this regard the best results are achieved with a trap density comprised between 2*10¹⁸ and 9*10¹⁸ traps/cm³.

Preferred doped rare earths orthosilicates to carry out the invention are Lu₂SiO₅ (hereinafter shortly indicated under the acronym LSO), Y₂SiO₅ (hereinafter shortly indicated under the acronym YSO) and Lu₂₋ₓYₓSiO₅ with x comprised between 0 and 2 (hereinafter shortly indicated under the acronym LYSO), doped with one or more rare earths chosen among: Ce, Pr, Nd, Sm, Eu, Gd, Tb, Dy, Ho, Er, Tm and Yb.

The inventors have found that some crystals possessing enhanced characteristics for the use in the applications under considerations have as main rare earth dopant Ce, Tb or their combination, while the secondary rare earth dopant is chosen between Pr, Nd, Sm, Eu, Gd, Dy, Ho, Er, Tm Yb and their combinations.

With main dopant it is intended the doping rare earth element or rare earth combination (as previously described Ce, Tb or Ce+Tb), with concentration being higher, even slightly, with respect to the presence of the secondary dopant or dopants combination.

The main dopant concentration level is, preferably, between 700 ppm and 5000 ppm (parts per million) and preferably comprised in the range between 3500 and 4500 ppm.

The inventors have also found that there are two different mechanisms that may lead to the formation of reproducible and sufficient intra-gap energy levels, acting as recombination centers, within the crystal. In the first one at least a second rare earth dopant is intentionally added, such second dopant having a much more stable transition between its upper energetic level and its lower energetic level, thus creating sites for the storage of information.

In this case it is important to have a secondary rare earth dopant or concentrations comprised between 100 and 5000 ppm, notwithstanding the previously expressed condition on the preferred nature and relationship between the main and secondary dopants. In case the secondary dopants consist of a mix of rare earths, then the previous condition is intended to be that the sum of all the secondary dopants has to be less than the amount of the main dopants.

The inventors have also found that the trap formation mechanism can be enhanced by means of growing the crystals in oxygen-poor atmosphere, or a suitable reducing atmosphere. A preferred solution in this case envisions the use of inert gases such as nitrogen or argon.

Also in this case useful crystals to carry out the invention are the following doped rare earths orthosilicates: Lu₂SiO₅ (hereinafter shortly indicated under the acronym LSO), Y₂SiO₅ (hereinafter shortly indicated under the acronym YSO) and Lu₂₋ₓYₓSiO₅ (with x comprised between 0 and 2) (hereinafter shortly indicated under the acronym LYSO), doped with one or more rare earths chosen among: Ce, Pr, Nd, Sm, Eu, Gd, Tb, Dy, Ho, Er, Tm and Yb.

When this mechanism of enhanced trap formation is used, it is possible to have a lower concentration for the secondary rare earth dopant, theoretically such secondary dopant may also be non present, since also in this case the paramount parameter for the use of rare earth doped orthosilicates is the density of the trap within the crystal, that as previously described may be achieved by means of rare earth co-doping, crystal growth in an oxygen poor atmosphere, or also by means of a combination of these mechanisms.

In the course of their studies, the inventors have also found a very convenient method to characterize the behavior of the crystal, such method allowing to understand and predict the suitability of the material as an efficient information recording media without the need of a complex chemical characterization of the crystal itself.

This method relies on the thermoluminescence characterization of the material after its exposure to a high energy source, such as X ray for a suitable amount of time, typically few minutes, followed by a well timed temperature scanning and a recording of the luminous emission of the irradiated sample.

In particular FIG. 5 shows a comparison of two thermoluminescence (TL) characterization curves of a YSO crystal grown in air (standard YSO), represented with thick line 51, and the same crystal grown in argon, represented with thinner line 52. The traps concentration was 1.5*10¹⁶ traps/cm³ for the first, and 9*10¹⁶ traps/cm³ for the argon grown crystal.

These curves have been obtained by irradiating the crystal samples with a X-ray source for 2 minutes, reading after 30 seconds the samples, and the thermoluminescence curves collected according to the well established experimental procedure for TL measurements.

It is clearly possible to observe that the thermoluminescence curve for the YSO crystal grown in Argon is much higher and also a numerical analysis integrating the areas gives a ratio of 6 between the thermoluminescence of YSO grown in argon and the one of standard YSO.

The use of co-doped rare earth orthosilicates for storage of information is not new and has been described in the pioneering U.S. Pat. No. 5,003,181. However this patent, focused on co-doped crystal containing Gadolinium, did not disclose or teach the importance of the trap phenomena and the importance of the correct density of such traps within the crystal structure in order to have efficient and reliable data recording.

On the other hand U.S. Pat. No. 6,846,434 discloses the use of a different material, Al₂O₃, requiring the concurrent presence of a different type of dopant, magnesium, and oxygen vacancies defects for optical data storage.

Therefore the enabling condition, or in some cases conditions, causing materials to become suitable for being used as means for recording information are different and require tailored studies and developments, like in the case of the use of Al₂O₃ as described in U.S. Pat. No. 6,846,434 and the material disclosed in the present invention.

In FIG. 6 there is shown a thermoluminescence characterization comparison of three crystals suitable for embodying the present invention; in particular curve 61 is referred to a YSO crystal with trap concentration of 8.5*10¹⁶ traps/cm³, curve 62 to a LSO crystal with trap concentration of 9.79*10¹⁸ traps/cm³, and finally curve 63 to a LYSO crystal with trap concentration of 8.4*10¹⁸ traps/cm³.

These curves were obtained with the same experimental set-up and procedure already described with reference to the results shown in FIG. 5.

It is possible to observe from FIG. 6 that YSO crystals possess enhanced characteristics that render them particularly suitable for being used as information storage media; in particular they release the stored information at higher temperatures, rendering the systems using these crystals for information storage and retrieval less insensitive to temperature fluctuations.

The information storage and retrieval may be applied in different technical fields, among the most interesting of which there are the electronic circuitry design and optical memories, the dosimetry and the radiographic imaging. Each of these specific fields, even if using the common concept for data storage outlined in claim 1, shows different aspects in terms of optimal trap density and recording and reading mechanism.

In particular in the optical memories application the information is preferentially stored and read by means of laser sources, preferably by means of laser diodes. Preferentially for data recording poli- and/or monochromatic sources are employed in the spectral range comprised between 5 MeV and 3 eV, while data reading, display and erase may be carried out with poli- and/or monochromatic sources in the spectral range comprised between 2.5 eV and 1.0 eV. Obviously the reading operation causes the display/retrieval of the stored data and at the same time erases the optical memory. It is to be remarked that the estimated potential residence time of the information within an optical memory realized according to the present invention is up to 10¹⁰ hours.

An alternative way to read and empty the optical memory, although less preferred, is via thermal excitation.

Another application benefiting from the information recording method of the present invention is the manufacturing of new components for electronic circuits suitable for selectively guiding an electrical signal along tracks recorded by means of optical excitation. This feature allows to use in a dynamic and cheap way the same sample for the manufacturing of different circuits.

In this specific application the high density of the crystalline matrix of the trapping defects, that does not allow the spatial diffusion of the charge carriers, is also exploited to its best, while allowing the transport of the charge only in the illuminated areas of the sample. A subsequent optical excitation of the circuit, i.e. the crystal after its exposition to incident radiation allows to delete the stored track or to dynamically modify the same.

Also in this case the recording mechanism of the conductive tracks occurs through luminous excitation with poli- and/or monochromatic sources having energies comprised in the spectral range between 5 MeV and 3 eV, whereas the partial or complete cancellation of such recorded tracks is carried out with optical excitation methods in the spectral range between 2.5 eV and 1.5 eV or in a less preferred embodiments by means of thermal methods.

The process may be repeated many times after a crystal has been emptied of the recorded information.

This very same concept can be used also in radiography: in this case the crystal will store the information coming from X-rays emerging from the radiographed sample, such radiographic image stored within the crystal may be read at a later stage allowing also the recording in digital format.

FIG. 7A shows a radiographic image of a screw of the type 307A SBY, obtained exposing a 4 mm thick crystal of Ce:LYSO with a cerium content of 1000 ppm to a 20 KeV X-ray radiation for 2 minutes, and reading the stored information by means of a He—Ne laser emitting radiation at 632 nm with an intensity of 1 mW/cm².

In order to overcome possible reading problems with the format of such image, a drawing showing its most representative elements is shown in FIG. 7B, where 71 represents the rare earth orthosilicate crystal used for storing and retrieving the image, 72 the read image from a recording camera (not shown) optically filtered in order to “cut” the scattered laser radiation (not shown).

This example shows that the information handling method of the invention may be applied onto the generic field of digital radiography, even though its preferred application is within the medical diagnostic field.

The method for recording information object of the present invention may be also used in dosimetry, These materials in fact are effective instruments to evaluate the radiation dose accumulated by persons working in environments exposed to ionizing radiations on a time basis that can vary from 24 hours to months according to the average trapping time of the active defect.

This information storage method applied to dosimetry offers advantages against the commercially available devices for environmental detection of ionizing energies that are based on reading systems through thermoluminescence measurement, since those devices requires specific and expensive apparatuses and above all long periods in order to collect information. Therefore, non-conventional materials are sought for this type of dosimeters, so that the process of reading the accumulated dose occurs through quicker and simpler measurements from the instrumental point of view.

At present, the most common optical reading devices for environmental detection of ionizing energies are based on Al₂O₃ crystals doped with carbon. However, the effective low atomic number of the constituting elements (low stopping power) results in a reduced efficiency of these devices, thus not facilitating their use in most applications.

In the materials used to carry out the invention, the effective high atomic number of the constituting elements and the procedures for counting the charges trapped in the defects of the crystalline matrix upon exposure to ionizing radiations (optical or thermal de-excitation with poli- and/or mono-chromatic sources with subsequent registration of the light emitted from the system) allow to overcome the limits of the presently available devices. Moreover the stopping power for the incoming radiation causes these materials to be more sensitive for radiation capture with particular reference to low energy radiations, such as X-rays, rendering the use of these materials for digital radiography extremely interesting also in view of the possibility of reducing the doses for the patients in case of medical diagnostic purposes.

This feature and its characteristics are shown in FIG. 8 where the comparison of the stopping power expressed in cm²/g and crystals, as a function of the energy of the incoming photon is shown. Curve 81 represent the data for human skin, curve 82 Al₂O₃ and curve 83 LYSO.

Consequently, with the above materials the effective high atomic number of the constituting elements and the procedures for counting the charges trapped in the defects of the crystalline matrix (upon exposure to ionizing radiations and subsequent data reading by means of optical de-excitation with poli- and/or mono-chromatic sources, with subsequent registration of the light emitted from the system) allow to overcome the limits of the presently available devices.

In a second aspect thereof the object of the invention consists in providing devices for information storage and retrieval employing as storing element doped rare earth orthosilicates, characterized in that said doped rare earth orthosilicates show a trap density comprised between 10¹⁵ and 10²⁰ traps/cm³.

Useful examples of devices that benefit from this information storage and retrieval mechanism are optical memories and systems for electronic circuit design.

Devices of particular interest in the medical field are dosimeters and radiographic storage support and their correspondent reading systems, even though the radiographic recording method according to the present invention may find application also in industrial diagnostic tools.

1. Method for information storage and retrieval employing as storing element doped rare earth orthosilicates, characterized in that said doped rare earth orthosilicates show a trap density comprised between 10¹⁵ and 10²⁰ traps/cm³.

2. Method according to claim 1, wherein the trap density is between 10¹⁶ and 10¹⁹ traps/cm³.

3. Method according to claim 1, wherein the trap density is between 2·10¹⁸ and 9·10¹⁸ traps/cm³.

4. Method according to claim 1, wherein said doped rare earth orthosilicate is selected from LSO, YSO and LYSO, and said dopant is one or more rare earths selected from: Ce, Pr, Nd, Sm, Eu, Gd, Tb, Dy, Ho, Er, Tm and Yb.

5. Method according to claim 4, wherein said doped rare earth orthosilicate has as main rare earth dopant Ce, Te or their combination.

6. Method according to claim 5, wherein said main rare earth dopant concentration is comprised between 700 ppm and 5000 ppm.

7. Method according to claim 6, wherein said rare earth dopant concentration is comprised between 3500 and 4500 ppm.

8. Method according to claim 4, wherein said rare earth doped orthosilicate contains at least a secondary rare earth dopant selected from Pr, Nd, Sm, Eu, Gd, Dy, Ho, Er, Tm Yb.

9. Method according to claim 8, wherein the overall concentration of the secondary rare earth dopant or dopants is lower than the concentration of the main rare earth dopant and comprised between 100 and 5000 ppm.

10. Method according to claim 1, wherein said rare earth doped orthosilicate crystal is grown in a reducing atmosphere.

11. Method according to claim 10, wherein said rare earth doped orthosilicate is grown in argon or nitrogen.

12. Device for information storage and retrieval comprising as storing element doped rare earth orthosilicates, characterized in that said doped rare earth orthosilicates show a trap density comprised between 10¹⁵ and 10²⁰ traps/cm³.

13. Information storage and retrieval device according to claim 12, wherein said device is an optical memory.

14. Information storage and retrieval device according to claim 12, wherein said device is an electronic circuit manufacturing system.

15. Information storage and retrieval device according to claim 12, wherein said device is a radiographic imaging system.

16. Information storage and retrieval device according to claim 12, wherein said device is a medical radiographic imaging system.

17. Information storage and retrieval device according to claim 12, wherein said device is a radiation dosimeter.

18. Information storage and retrieval device according to claims 12-14, wherein the information is stored by means of ionizing radiation of poli- and/or monochromatic sources with energies comprised between 5 Mev and 3 eV.

19. Information storage and retrieval device according to one of claims 12-16, wherein the stored information is retrieved by means of optical excitation methods with sources having energies comprised between 2.5 and 1.5 eV.

20. Information storage and retrieval device according to one of claims 12-16, wherein the stored information is retrieved by means of thermal de-excitation.
